(19) United States
(12) Patent Application Publication
(10) Pub. No.: US 2009/0212250 A1
(43) Pub. Date: Aug. 27, 2009

(54) LOCKOUT VALVE

(76) Inventors: Lawrence E. Brice, Armada, MI (US); John A. Kempf, Clarkston, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/390,595

(22) Filed: Feb. 23, 2009

Related U.S. Application Data
(60) Provisional application No. 61/030,372, filed on Feb. 21, 2008.

(51) Int. Cl. F16K 3/00

(52) U.S. Cl. 251/326

(57) ABSTRACT

A lockout valve operable to control fluid between two components is provided. The lockout valve includes a housing having a flow passage, an intake port, an outtake port, and an exhaust port selectively in communication with the flow passage. The lockout valve further includes a slide slidably mounted to the housing between an open position and a closed position. The slide includes a vent disposed and a through port extending through the slide. When the slide is in the open position, the through port is disposed between the intake port and the outtake port, providing a passage for fluid. When the slide is in the closed position, the vent is fittingly disposed between the intake port and the outtake port so as to prevent fluid from flowing downstream the lockout valve and to allow fluid pressure downstream the lockout valve to escape through the exhaust port.

### CROSS-REFERENCE TO RELATED APPLICATIONS

This application claims priority of U.S. Provisional Patent Application Ser. No. 61/030,372 filed Feb. 21, 2008, which is incorporated herein by reference.

### FIELD OF THE INVENTION

The present invention relates generally to a pneumatic valve and, more specifically, to a lockout valve that controls fluid flow in a fluid system having an exhaust port.

### DESCRIPTION OF THE RELATED ART

Various types of fluid systems are known in the art that rely on the fluid flow of pressurized air. An example of a fluid system is a pneumatic system. These types of fluid systems periodically need maintenance, which requires careful control of the airflow supply to the system, as well as control of the airflow already within the system. Various types of valves are well known in the art for controlling the flow of fluid in a fluid system.

For example, a type of valve referred to as a lockout valve typically includes a slide that may be positioned to control the fluid flow passing through the valve. The lockout valve provides for predetermined levels of flow, such as fully open, fully closed and an intermediate, partial flow, position. The slide is positioned in the open position when maximum fluid flow is desirable. The slide is positioned in the closed position when it is desirable to prevent fluid flow downstream the valve.

The slide may be locked in the closed position using an external locking mechanism, such as a padlock, to prevent the unintended movement of the slide. The slide may be positioned in an intermediate, or bleed position, to provide partial flow through the valve. This position is advantageous when restricted flow is desirable until the pressure within the system equalizes. It should be appreciated that certain types of equipment may be damaged by rapid changes in air pressure.

One example of a lockout valve that provides for a gradual buildup of pressure across the valve in an open position to protect other components within the system is disclosed in U.S. Patent to Brice et al. In some applications it is desirable to have a rapid exhaust of downstream pressure.

### SUMMARY OF THE INVENTION AND ADVANTAGES

A lockout valve operable to control fluid between two components is provided. The lockout valve includes a housing having a flow passage, an intake port, and an outtake port. The housing also includes an exhaust port selectively in communication with the downstream side of the flow passage. The lockout valve further includes a slide slidably mounted to the housing. The slide is slidable between an open position and a closed position.

The slide includes an upstream surface opposite a downstream surface. The slide further includes a vent disposed on the downstream surface and a through port extending between the downstream surface and the upstream surface. When the slide is in the open position, the through port is disposed between the intake port and the outtake port so as to provide a passage for fluid. Wherein when the slide is in the closed position, the vent is disposed between the intake port and the outtake port so as to prevent fluid from flowing downstream the lockout valve and to allow fluid pressure downstream the lockout valve to escape through the exhaust port. Specifically, the upstream surface prevents fluid from moving downstream the lockout valve and the vent is placed in communication with the downstream flow passage.

### BRIEF DESCRIPTION OF THE DRAWINGS

FIG. 1 is an illustration of a first preferred embodiment of the lockout valve wherein the slide is in the closed position;

FIG. 2 is an illustration of a lockout valve wherein the slide is in the open position;

FIG. 3 is an exploded view showing the component of the lockout valve of FIGS. 1 and 2;

FIG. 4 is a cross section of FIG. 2 taken along lines 4-4, showing the through port disposed between the intake and outtake port for maximized fluid flow;

FIG. 5 is a cross section of FIG. 1 taken along lines 5-5, showing the vent disposed between the intake and outtake port, pressure downstream forces fluid through the vent to and out the exhaust port where the fluid is collected at the muffler;

FIG. 6 is a top down view of the FIG. 1;

FIG. 7 is a cross section of FIG. 6 taken along lines 7-7, showing the detent and locking mechanism;

FIG. 8 is an illustration of the second preferred embodiment of the lockout valve in the open position, wherein the lockout valve includes a spacer and a diverter;

FIG. 9 is an illustration of the slide shown in FIG. 8;

FIG. 10 is a cross section of FIG. 8, showing the through port disposed between the intake and outtake port; and

FIG. 11 is a view of FIG. 10 showing the slide moved to the closed position, the vent is disposed between the intake and outtake port, pressure downstream the lockout valve causes fluid to escape through the vent and out the exhaust port.

### DETAILED DESCRIPTION OF THE INVENTION

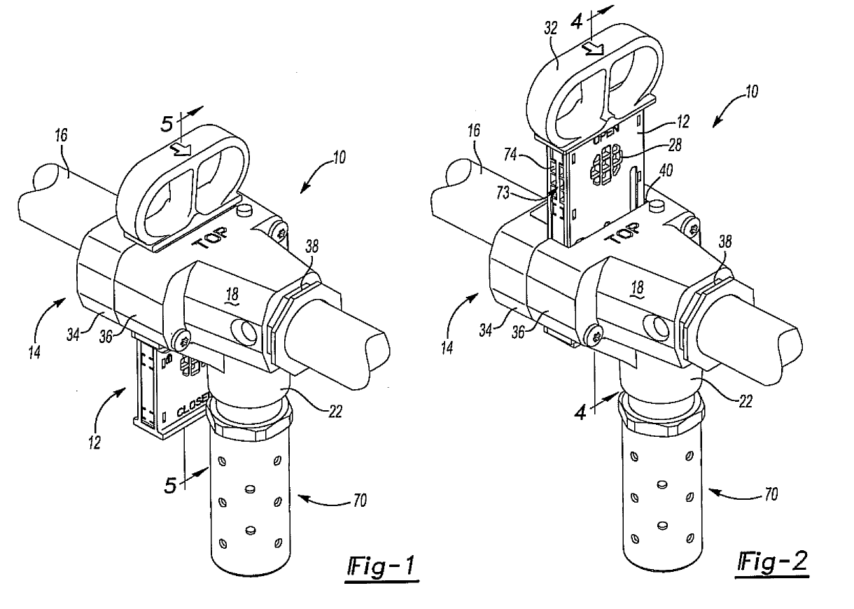

A lockout valve 10 having a slide 12 slidingly mounted within a housing 14 is provided in FIG. 1. The housing 14 includes an intake port 16 located upstream an outtake port 18. The housing 14 further includes a flow passage 20 and an exhaust port 22. The intake port 16 and outtake port 18 are configured to attach to a component such as a supply line (not shown).

The slide 12 is slidably mounted in the housing 14 and is moveable between a closed position and an open position so as to place the exhaust port 22 in communication with the downstream side of the flow passage 20. The slide 12 has an upstream surface 24 and a downstream surface 26, and also includes a vent 28 spaced apart from a through port 30. The slide 12 is movable between the closed position and the open position so as to control the movement of fluid between the two attached components.

With reference again to FIG. 1, an illustration showing the slide 12 in the closed position is provided. When the slide 12 is moved to the closed position, the vent 28 is disposed between the intake port 16 and the outtake port 18. The upstream surface 24 of the slide 12 prevents fluid from flowing downstream the lockout valve 10. The vent 28 interconnects the fluid downstream the lockout valve 10 to the exhaust port 22. Specifically, the vent 28 has an opening disposed on the downstream surface 26 of the slide 12 and is in communication with the downstream side of the flow passage 20. The vent 28 provides a passage for fluid contained downstream the lockout valve 10 to equalize when the lockout valve 10 is in the closed position. The area of the exhaust port 22 may thus be equal to or greater than the supply of downstream fluid so that there is rapid exhaust of pressure.

With reference now to FIG. 2, an illustration showing the slide 12 in the open position is provided. When the slide 12 is moved to the open position, the through port 30 is disposed between the intake port 16 and the outtake port 18. The through port 30 extends between the upstream surface 24 and the downstream surface 26. Accordingly, the through port 30 provides for maximized flow of fluid downstream the lockout valve 10 when the lockout valve 10 is in the open position.

The slide 12 may further include a handle 32 disposed on either end of the slide 12. Any handle 32 currently known and used in the art may be suitable for use herein, illustratively including the handle 32, shown in FIG. 1. The handle 32 is configured to be gripped by a person. For instance, the handle 32 may be a generally ovular ring having a member extending across the ring so as to enclose two spaces, wherein each of the two spaces is adapted to receive the fingers of a user so as to provide a surface for gripping the slide 12.

The housing 14 may include an upstream housing member 34, and a downstream housing member 36. The two housing members 34, 36 are joined together to define a flow passage 20. The two housing members 34, 36 may be joined together using a known fastening device 35, such as a screw. The exhaust port 22 is disposed on the housing 36, and the slide 12 is operable to connect the downstream side of the flow passage 20 to the environment.

The intake port 16 is disposed on the upstream housing member 34 and includes an outer opening 16a and an inner opening 16b. The outtake port 18 is disposed on the downstream housing member 36 and also includes an outer opening 18a and an inner opening 18b. The inner opening 16b of the intake port 16 extends into the housing 14 towards the inner opening 18b of the outtake port 18. Likewise, the inner opening 18b of the outtake port 18 extends into the housing 14 towards the inner opening 16b of the intake port 16. Accordingly, the inner opening 16b of the intake port 16 is spaced apart from the inner opening 18b of the outtake port 18. The intake port 16 and the outtake port 18 may be integrally formed as part of the housing 14. The housing 14 is preferably manufactured using a known metal material and a known metal-forming technique, such as casting or stamping, or the like.

The outer opening 16a, 18a of each of the intake and the outtake ports 16, 18 may include a connector 38 for connecting the lockout valve 10 to another component (not shown), such as a machine, filter, or regulator. An example of a connector 38 is a threaded connection. It should be appreciated that the lockout valve 10 may be used to interconnect two components.

The housing 14 further includes a slide channel 40 extending transversely between an upper opening formed in an upper end of the housing 14, and a lower opening formed in a lower end of the housing 14. The slide 12 is slidingly disposed within the slide channel 40, and is movable between an open position and a closed position. The slide 12 may extend out beyond the upper opening in the upper end of the housing 14 and the lower opening in the lower end of the housing 14.

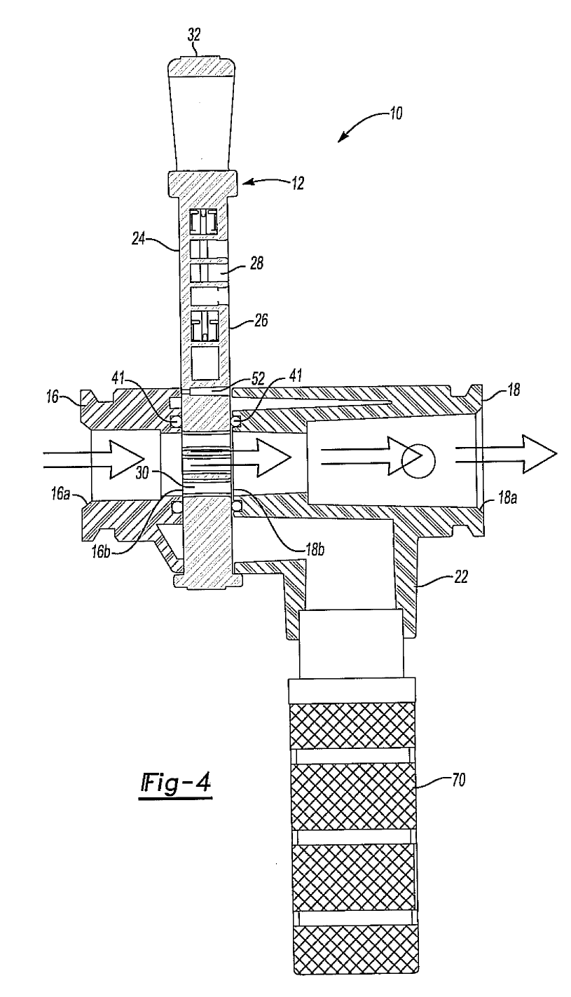

The lockout valve 10 may also include at least one seal 41, such as an o-ring 41, for sealing the slide 12 to the inner end of the intake and outtake port 16, 18. The o-ring 41 is preferably disposed around inner opening 16b, 18b of both the intake port 16 and outtake port 18. With reference to FIG. 4, the valve is shown having two o-rings. One o-ring is compressed between the slide 12 and the inner opening 16b of intake port 16, and the other o-ring is compressed between the slide 12 and the inner opening 18b of the outtake port 18. Thus, the o-rings help direct the flow of fluid.

The slide 12 may include indicia 42 on the upstream surface 24 or downstream surface 26, such as the words “open” or “closed”, to provide a visual indicator to a user whether the lockout valve 10 is open or closed. The indicia 42 may be molded in the slide 12 or a label or the like that is affixed to the slide 12.

The slide 12 may further include a lockout aperture 44. In this example the lockout aperture 44 is positioned adjacent the through port 30. Specifically, the lockout aperture 44 is disposed on slide 12 below the housing 14 when the slide is moved to the open position, and extends between the upstream surface 24 and the downstream surface 26. An external locking mechanism (not shown), such as a padlock, may be disposed in the lockout aperture 44, to prevent inadvertent movement of the slide 12 through the housing 14 when the slide 12 is in a closed position. Accordingly, the slide 12 may only be locked, when the slide 12 is in the closed position.

The housing 14 may include a sensor port 46 configured to engage a sensor. For instance, a pressure gauge may be mounted to the sensor port 46 to sense and display the pressure in the outlet conduit. As shown in FIG. 1, the sensor port 46 may be formed to the downstream passage for mounting a pressure sensor. Thus the sensor can provide an indication of whether all of the pressure has been exhausted when the valve is closed.

Baffles 48 may be formed on inner surfaces of the housing members 34, 36 to reduce noise of any pressure passing through the exhaust port 22. Preferably, the baffles 48 are formed of a porous media to permit flow but reduce noise.

The slide 12 may further include a bleeder hole 52 disposed between the through port 30 and the vent 28. The bleeder hole 52 is positioned to provide for the restricted flow of fluid between the intake port 16 and the outtake port 18 when the slide 12 is in an intermediate position.

It should be appreciated that in a closed position of the lockout valve 10, fluid is blocked from passing between the intake port 16 and the outtake port 18. Fluid downstream the lockout valve 10 will be allowed to vent 28 to the atmosphere through the exhaust port 22. In the intermediate position of the lockout valve 10, fluid flow between the intake port 16 and outtake port 18 is restricted through bleeder hole 52, preferably until the pressure within the fluid system is equalized. In the open position of the lockout valve 10, fluid flow between the intake port 16 and outtake port 18 is not restricted.

In another embodiment of the bleeder hole 52, the bleeder hole is defined by a portion of a pair of overlapping slots formed on opposing surfaces of the slide. For instance, the upstream surface 24 of the slide 12 may includes a longitudinally extending detent slot 54. The detent slot 54 is positioned halfway between the open end and closed end, and near the outer edge of the slide 12. The detent slot 54 is of a predetermined length, width and depth.

The downstream surface 26 of the slide 12 further includes a longitudinally extending override slot 56. The override slot 56 has a predetermined length, width and depth. An upper portion of the override slot 56 is positioned over the detent slot 54 on the upstream surface 24 of the slide 12. The detent slot includes a catch 53. The catch 53 is disposed at the end of the detent slot 54 closest towards the bottom end of the slide 12, as shown in FIG. 7. A lower portion of the override slot 56 does not extend all the way through the slide 12. Therefore, where the detent slot 54 and upper portion of the override slot 56 overlap, a continuous passageway is formed, wherein restricted fluid flow may occur until the pressure within the system equalizes.

The slide may further include a locking mechanism 55 operable to stop the slide into the intermediate position when the slide is moved between the closed and open position. For instance, the stopping mechanism 55 may include a biasing member 64, such as a spring, and a ball member 66. The biasing member 64 and the ball member 66 are positioned in a recessed area of the housing 14. The ball member 66 is slidingly mounted in the detent slot 54. When the slide is moved between the closed and open position, the spring 64 urges the ball 66 against the detent slot so as to position the ball 66 against the catch 53 and prevent the slide from advancing. When the ball 66 abuts against the catch 53, the slide 12 is positioned within the housing 14 such that the bleeder hole 52 is disposed between the intake and outtake port 16, 18. When closing the valve the stopping mechanism 55 has no effect. Specifically, as the slide 12 moves from the open to the closed position, the ball member 66 is free to move out of the detent slot 54.

As disclosed in U.S. Patent, the lockout valve 10 may further includes a detent mechanism 58 for overriding an intermediate position of the slide 12, thus allowing continuous movement between an open position and a closed position. The detent mechanism 58 includes a detent override lever 60 positioned partially inside the housing 14 and partially outside. Preferably, the detent override lever 60 is in the same plane as the slide 12. The detent override lever 60 includes a finger 62 extending outwardly from the override lever 60, and engaging the ball member 66.

In operating the lockout valve 10, the ball is initially located in the upper portion of the detent slot 54 when the lockout valve 10 is in a closed position. If the user wants to go directly to the full open position of the lockout valve 10, the slide 12 is pushed into the housing 14 until the flange 68 of the slide 12 hits the housing 14, to open the lockout valve 10. At the same time, the ball member 66 travels in the detent slot 54 of the slide 12 until the ball member 66 hits a bottom edge of the detent slot 54 in order to stop the sliding movement of the slide 12. The length of the detent slot 54 is determinable to allow the ball to travel between the closed and the intermediate position of the slide 12.

Actuation of the override lever 60 causes an edge 61 of the override lever 60 to hit an edge 59 of the inside of the housing 14. Advantageously the detent override lever 60 can be actuated while pushing the slide 12 to avoid the intermediate position, or initially from the intermediate position. Actuation of the detent override lever 60 forces the finger 62 into the ball 66, pushing the ball 66 out of the detent slot 54 and into the recessed area 63 of the housing 14, thus freeing the slide 12 to move to the open position.

To close the lockout valve 10, the slide 12 is pushed from the open end of the slide 12 mechanism into the housing 14, and the ball 66 falls into the detent slot 54 without any restriction. To position the lockout valve 10 in an intermediate position, the slide 12 is pushed into the housing 14 until stopped by locking mechanism 55. To position the lockout valve 10 in closed position, the detent lever is actuated as previously described

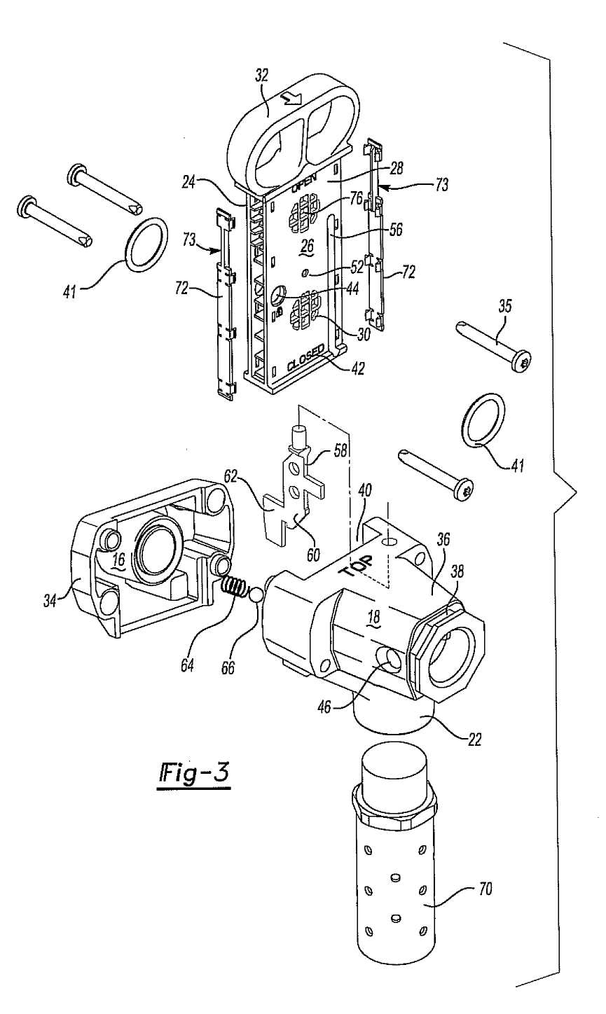

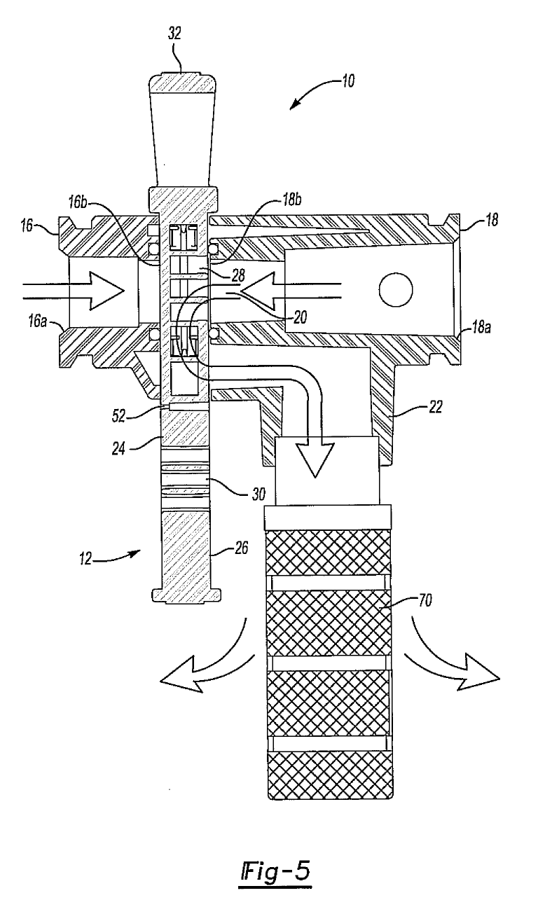

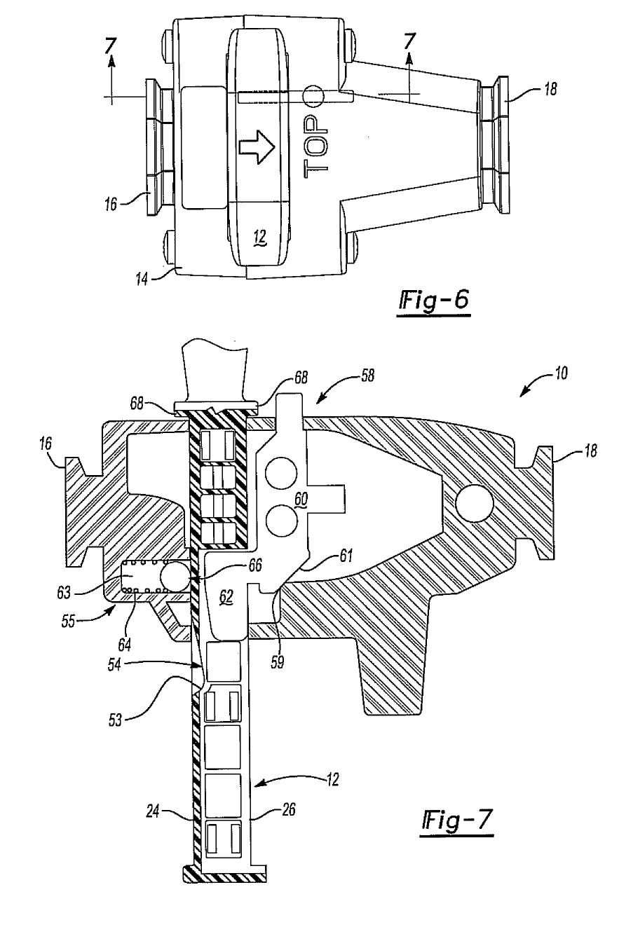

With reference now to FIGS. 1-7, a preferred embodiment of the valve is provided wherein the exhaust port 22 is configured to fittingly connect to a muffler 70 or a pressure accumulator (not shown). The exhaust port 22 is placed in communication with the flow passage 20 when the slide is moved to the closed position. Thus, fluid pressure located downstream the lockout valve 10 will attempt to equalize when the slide 12 is moved to the closed position. Similar as described above, fluid pressure directs the fluid downstream the lockout valve 10 to move through the opening of the vent 28 out the exhaust port 22 into the attached muffler 70 or accumulator.

With reference again to FIG. 1, the exhaust port 22 is shown disposed on the downstream housing member 36. The exhaust port 22 includes an opening configured to engage a muffler 70. Mufflers 70 and accumulators are currently known and used in the art, and any such muffler 70 or accumulator is suitable for use herein, illustratively including the muffler 70 shown in FIG. 1. The pressure accumulator may include a device operable to induce a suction so as to facilitate the equalization of pressure and collect fluid downstream the valve.

The slide 12 may further include a pair of spaced apart sidewalls 72. Each of the sidewalls 72 interconnects the downstream surface 26 to the upstream surface 24. The sidewalls 72 include sidewall openings 74 in communication with the exhaust port 22. The vent 28 extends from the downstream surface 26 to the sidewall openings 74 so as to provide a passage for fluid downstream the lockout valve 10 to the exhaust port 22 when the slide 12 is in the closed position.

The slide 12 may also include a wall 76 disposed within the vent 28. The wall 76 is configured to prevent the passage of an elongated member between the sidewall openings 74. Specifically, the wall 76 is disposed within the vent 28 between the sidewalls 72. The wall 76 generally bisects the vent 28 to as to direct fluid into each of the sidewall openings 74, while simultaneously preventing direct passage between the sidewall openings 74. Accordingly, an elongated member such as a chain lock or a pencil may not pass through the sidewall openings 74 so as to prevent the slide 12 from being moved from the closed position to the open position.

The sidewalls 72 may further include an elongated bar 73 disposed within the sidewall openings 74. The elongated bar 73 extends longitudinally across the sidewall openings, partially blocking the sidewall openings 74 so as to help prevent the insertion of objects into the vent 28.

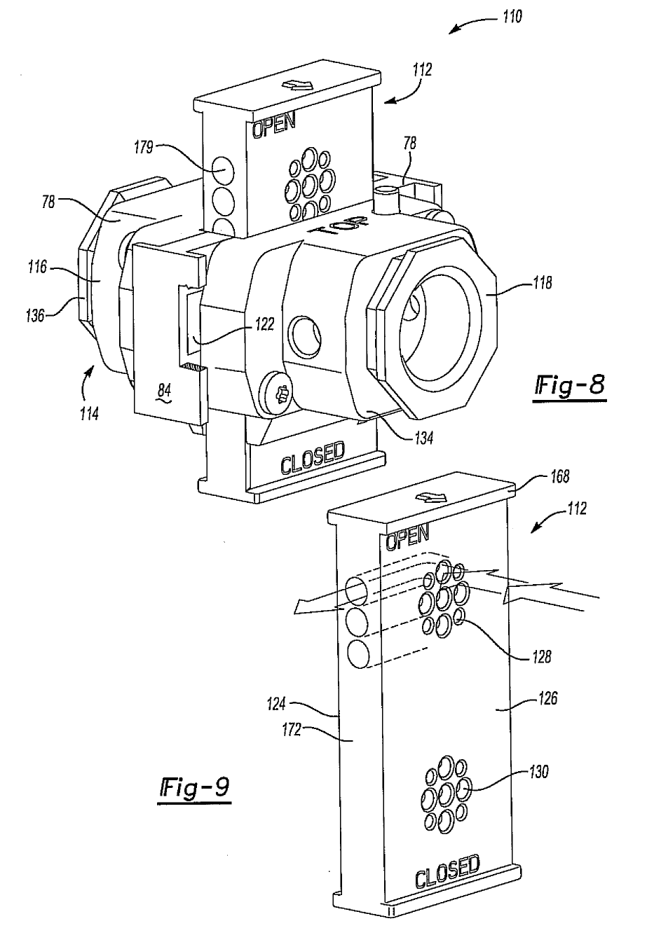

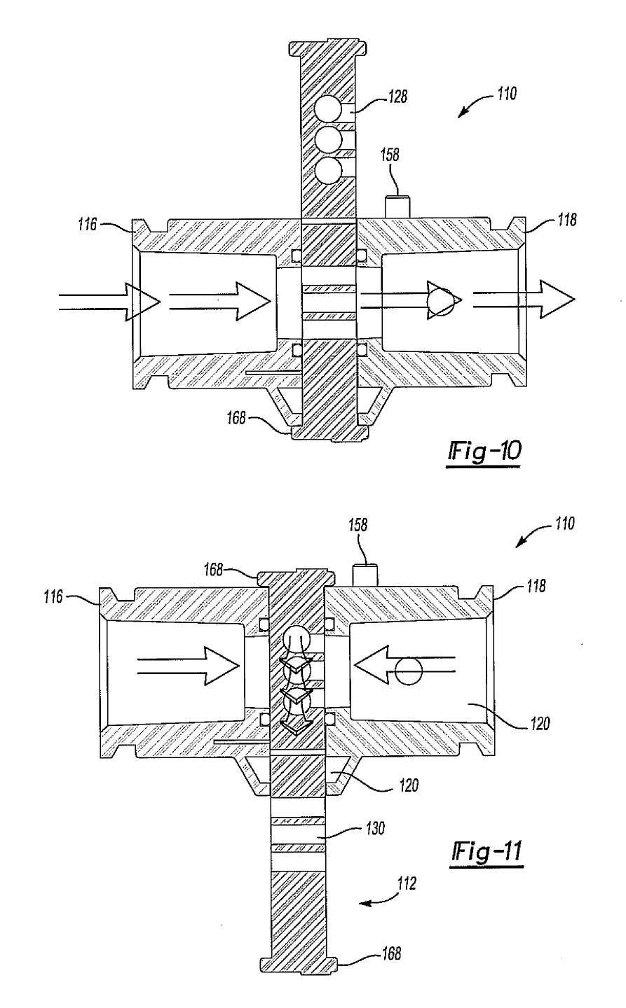

With reference now to FIGS. 8-11, a second preferred embodiment of the lockout valve 110 is provided. Like features have like reference numerals increased by 100. Upstream and downstream housing members 134, 136 are identical to each other. A spacer 78 is disposed between the upstream and downstream housing member 134, 136. The spacer 78 may include a throughbore 79 to accept a fastener 80 such as a mounting screw. The spacer 78 is configured to define the exhaust port 122. For instance in one embodiment the housing 114 includes a pair of spacers 78 is mounted in between the upstream and downstream housing members 134, 136. The spacers 78 are spaced apart from each other so that there is a passageway between the housing members 134, 136 and arms 82. The passageway forms the exhaust port 122.

The lockout valve 110 may further include a diverter 84 disposed on each arm 82. The diverter 84 extends a predetermined distance away from the housing 114. Preferably, the diverter 84 is integrally molded or stamped with the arm 82. For instance, the diverter 84 includes a diverting surface 50 which may be an end wall 50 of the arm 82 having a planar surface, which is normal to the direction of the arm 82 and is wider than the thickness of the arm 82. Fluid flowing from downstream passes through the vent 128 into the exhaust port 122 and is deflected by the diverter 84 so that it is directed away from an operator.

The present invention has been described in an illustrative manner. It is to be understood that the terminology which has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A lockout valve operable to control fluid between two components, the lockout valve comprising:
a housing including an intake port spaced apart an outtake port, and wherein the housing further includes a flow passage in communication with an exhaust port; and
a slide slidably mounted to the housing, wherein the slide is slidable between an open position and a closed position, the slide including an upstream surface and a downstream surface, the slide further including a vent disposed on the downstream surface, and a through port extending between the downstream surface and the upstream surface, and wherein when the slide is in the open position, the through port is disposed between the intake port and the outtake port so as to provide a passage for fluid, and wherein when the slide is in the closed position, the vent is disposed between the intake port and the outtake port and in communication with the flow passage, wherein the upstream surface prevents fluid from moving downstream the lockout valve, and wherein pressure downstream the lockout valve forces fluid downstream of the lockout valve to escape through the vent to the flow passage and out the exhaust port.

2. The device as set forth in claim 1, wherein the slide further includes a pair of sidewalls, wherein each of the pair of sidewalls is spaced apart from each other, wherein the pair of sidewalls extends between the upstream surface and the downstream surface, and wherein the each of the pair of sidewalls include a sidewall opening, and wherein the vent is in communication with each of the sidewall openings.

3. The device as set forth in claim 2, further including a wall, the wall extending between the inner surfaces of the vent so as to prevent an object from being inserted between the sidewall openings.

4. The device as set forth in claim 2 wherein each of the pair of sidewalls further includes at least one elongated bar extending longitudinally across the sidewall opening so as to prevent objects of a predetermined size from being inserted into the vent.

5. The device as set forth in claim 1 wherein the slide further includes a handle, the handle operable to facilitate the movement of the slide between the closed and open position.

6. The device as set forth in claim 1, further including at least one seal disposed between the slide and one of either the intake or outtake port, wherein the seal is compressed between the slide and one of either the intake or outtake port so as to control the movement of fluid.

7. The device as set forth in claim 1, further including a sensor port disposed on the housing, the sensor port configured to accept a sensor.

8. The device as set forth in claim 1, wherein the exhaust port is configured to receive one of either a muffler or an accumulator.

9. The device as set forth in claim 8, wherein the opening of the exhaust port is the same or larger than the opening of the inlet port.

10. The device as set forth in claim 1, wherein the slide further includes a bleeder hole disposed between the vent and the through port, the bleeder hole extending between the upstream surface and downstream surface of the slide, and wherein when the slide is moveable to an intermediate position where the bleeder hole is disposed between the intake port and outtake port.

11. The device as set forth in claim 10, further including a detent slot, the detent slot extending longitudinally along the downstream surface of the slide, and an override slot extending longitudinally on the upstream surface of the slide, wherein a portion of the detent slot overlaps a portion of the override slot so as to define the bleeder hole.

12. The device as set forth in claim 10, wherein the slide includes a locking mechanism for locking the bleeder hole into the intermediate position, wherein the locking mechanism is disposed in the housing, and includes a biasing member and an ball member, the biasing member urging the ball member against the detent slot so as to place the slide in an intermediate position when moved between the open and closed position.

13. The device as set forth in claim 11, wherein the slide further includes a detent mechanism for overriding the locking mechanism, the detent mechanism including a detent override lever disposed in the housing, wherein a portion of the override lever extends from the housing, the detent override lever having a finger engaging the ball member, wherein actuation of the detent lever urges the finger against the ball member so as to urge the ball member out of the detent slot and free the slide for unrestricted movement between the open and closed position.

14. The device as set forth in claim 1, wherein the housing includes an upstream housing member and a downstream housing member.

15. The device as set forth in claim 1, further including baffles disposed along the inner surface of the housing.

16. The device as set forth in claim 12, wherein the exhaust port is disposed on the downstream housing member.

17. The device as set forth in claim 12, further including a spacer disposed between the upstream housing member and the downstream housing member, the spacer displacing the upstream housing member from the downstream housing member so as to form the exhaust port.

18. The device as set forth in claim 15, further including a diverter disposed on the spacer and spaced apart from the housing, the diverter including a diverting surface for diverting the flow of fluid leaving the exhaust port.
